(19) United States
(12) Patent Application Publication
(10) Pub. No.: US 2016/0296420 A1
(43) Pub. Date: Oct. 13, 2016

(54) FLUID SAMPLE TRANSFER ADAPTOR AND RELATED METHODS AND DEVICES

(71) Applicant: WAYNE STATE UNIVERSITY, Detroit, MI (US)

(72) Inventor: Hossein SALIMNIA, Rochester Hills, MI (US)

(21) Appl. No.: 15/100,561

(22) PCT Filed: Dec. 4, 2014
(86) PCT No.: PCT/US14/68651

§ 371 Date: May 31, 2016

Related U.S. Application Data
(60) Provisional application No. 61/911,901, filed on Dec. 4, 2013.

(51) Int. Cl. A61J 1/20; G01N 1/38; B01L 3/00; A61J 1/14

(52) U.S. Cl. CPC A61J 1/2013; A61J 1/2089; A61J 1/1406; G01N 1/38; B01L 3/5021; A61J 2205/10; A61J 2205/30; B01L 2200/025; B01L 2300/0832; B01L 2200/0689; B01L 2300/044

(57) ABSTRACT

Embodiments relate to needled fluid transfer adaptors, and related methods and systems for transferring fluid samples between fluid vessels having sealing means.

### SUMMARY

In general, this disclosure describes techniques for transferring fluid samples between fluid containment vessels or fluid containing components. Techniques further describe the labeling and handling of sample vessels. In particular, this disclosure describes techniques for transferring or aliquoting medical samples from a sample vessel to one or more aliquot vessels. It should be noted that although the techniques of this disclosure are described with respect to examples for aliquoting medical samples in clinical laboratories, the techniques described herein are generally applicable to the transfer of any manner of fluid samples in laboratory settings or otherwise.

According to one example of the disclosure, an aliquot transfer sample tube adaptor comprises a body having a first end and a second with an axial internal bore running therebetween, a support means intermediate the first end and the second end defining a first receiving cavity and a second receiving cavity, and a needle substantially axially oriented within the internal bore and maintained in position by the support means comprising a first tip intermediate the body first end and the support means and a second tip intermediate the body second end and the support means. In some other embodiments, the needle further comprises at least two apertures on opposing sides of the support means and exposing a lumen internally disposed along a length of the needle. In some embodiments, the adaptor further comprises a needle sheath. In other embodiments, at least one of the needle first tip and needle second tip extend beyond the body first end and body second end, respectively.

According to another example of the disclosure, an aliquot transfer sample tube adaptor as described above can include apertures variously positioned throughout the needle, such as proximate each needle tip. In other examples, the needle may comprise one or more apertures clustered near the support means on one or both sides of the needle. In certain embodiments, one aperture is located proximate to each needle tip, and a radial aperture cluster is located proximate the support means on one needle side. In other embodiments, one or more needle apertures are sized to prevent particulate from passing therethrough.

According to another example of the disclosure, a sample transfer system comprises an aliquot transfer sample tube adaptor comprising a body having a first end and a second with an axial internal bore running therebetween, a support means intermediate the first end and the second end defining a first receiving cavity and a second receiving cavity, and a needle substantially axially oriented within the internal bore and maintained in position by the support means, the needle having a first tip intermediate the body first end and the support means, and a second tip intermediate the body second end and the support means; and a plurality of vessels each having a sealing means actuable by a tip of the adaptor needle when positioned within a receiving cavity of the adaptor, and one or more of a plurality of vessels may be sequentially coupled via the sample vessel adaptor creating fluid communication therebetween. In some other embodiments the needle further comprises at least two apertures on opposing sides of the support means and exposing a lumen internally disposed along a length of the needle. In some embodiments of the sample transfer system, the sealing means of one or more of a plurality of vessels or tubes comprises a pierceable membrane.

According to another example of the disclosure, a method for transferring samples comprises providing a sample vessel adaptor comprising: a body having a first end and a second end with an axial internal bore running therebetween; a support means intermediate the first end and the second end defining a first receiving cavity and a second receiving cavity; and a needle substantially axially oriented within the internal bore and maintained in position by the support means, having a first tip intermediate the body first end and the support means, and a second tip intermediate the body second end and the support means; positioning a sample vessel within the first receiving cavity of the adaptor thereby causing the first needle tip to actuate the sealing means of the sample vessel from a sealed position to an unsealed position; and positioning an aliquot vessel within the second receiving cavity of the adaptor thereby causing the second needle tip to actuate the sealing means of the aliquot vessel; wherein fluid communication is established from the sample vessel to the aliquot vessel and fluid is transferred therebetween. In some other embodiments the needle further comprises at least one aperture on each opposing side of the support means and exposing a lumen internally disposed along a length of the needle. In some other embodiments, fluid communication between the sample vessel and the aliquot vessel is established via the needle lumen. In some embodiments, the sealing means of one or more of the aliquot vessel or sample vessel comprises a pierceable membrane. In still other embodiments, the methods for transferring samples further comprise inverting a coupled adaptor, sample vessel, and aliquot vessel to aid fluid flow into the aliquot vessel. In certain embodiments, the methods for transferring samples further comprise adding a separating gel to the sample tube to separate fluid components.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1A illustrates a perspective view of an aliquot transfer sample tube adaptor, according to one or more techniques of this disclosure.

FIG. 1B illustrates a cross-sectional view of an aliquot transfer sample tube adaptor positioned to mate with a fluid vessel having a pierceable top, according to one or more techniques of this disclosure.

FIG. 2A illustrates a perspective view of an aliquot transfer sample tube adaptor needle having multiple apertures, according to one or more techniques of this disclosure.

FIG. 2B illustrates a perspective view of an aliquot transfer sample tube adaptor having a plurality of various needle apertures, according to one or more techniques of this disclosure.

FIG. 3A illustrates a perspective view of an aliquot transfer sample tube adaptor comprising a needle sheath, according to one or more techniques of this disclosure.

FIG. 3B illustrates a cross-sectional view of an aliquot transfer sample tube adaptor comprising a needle sheath, according to one or more techniques of this disclosure.

FIG. 4A illustrates a perspective view of a bodiless aliquot transfer sample tube adaptor, according to one or more techniques of this disclosure.

FIG. 4B illustrates a perspective view of a bodiless aliquot transfer sample tube adaptor comprising a needle sheath, according to one or more techniques of this disclosure.

FIG. 5A illustrates a flow diagram of using an aliquot transfer sample tube adaptor to transfer a sample between a plurality of sample vessels, according to one or more techniques of this disclosure.

FIG. 6A and 6B illustrate a cross-sectional view of an aliquot transfer sample tube adaptor mated with two fluid vessels having pierceable caps, according to one or more techniques of this disclosure, wherein the needle is enlarged for the purposes of demonstration.

FIG. 7A illustrates a cross-sectional view of a sample vessel containing a fluid sample and a separating gel, according to one or more techniques of this disclosure.

FIG. 7B illustrates a cross-sectional view of a sample vessel containing a fluid sample separated into its components by a separating gel, according to one or more techniques of this disclosure.

FIG. 7C illustrates a cross-sectional view of a sample vessel containing a fluid sample and a separating gel mated with an aliquot transfer sample tube adaptor and a fluid vessel, according to one or more techniques of this disclosure.

FIG. 8A illustrates a device comprising needleless access port, according to one or more techniques of this disclosure.

FIG. 8B illustrates a luer-locking adaptor with a springed actuator, according to one or more techniques of this disclosure.

FIG. 8C illustrates a device comprising needleless access port mated with a luer-locking adaptor with a springed actuator, according to one or more techniques of this disclosure.

FIG. 9 illustrates a cross-sectional view of an aliquot transfer sample tube adaptor mated with two fluid vessels having pierceable caps, according to one or more techniques of this disclosure.

### DETAILED DESCRIPTION

Diagnostic laboratories play a major role in medicine today. Physicians are heavily dependent of laboratory test results for their clinical decisions. Laboratories have implemented quality control and quality management procedures to ensure the quality of lab results. One focus of efforts to prevent diagnostic errors involves pre-analytic steps. Laboratory test results are heavily affected by the quality of the samples which are impacted by pre-analytical steps. Generally, pre-analytical steps include patient identification and preparation, proper sample collection, accurate labeling of collected samples and transportation of sample to the lab. Correct labeling of patient samples is very crucial and any mistake can have significant medical, social and legal consequences. Mid-size or large clinical laboratories receive hundreds to thousands of patient samples every day for analysis. For a lean process and for better efficiency, many labs have created a specimen processing area which receives all patient samples, processes them and send them to the appropriate laboratory sections for testing.

The usual process after the receipt of sample include logging the sample into the laboratory information system (LIS), if the sample comes with a lab requisition form and if it has not already been ordered by health care provider through a computer system. Most laboratory analyzers cannot read the original label on the patient's sample. Sample processing sections usually create a new label that includes bar coded patient identifiers and test codes that allow automated analyzers in the lab to read the label, to perform the ordered test and to send the result to an electronic medical record. Manual transfer and labeling of these samples pose significant medical, social, and legal consequences. The techniques described herein reduce the risk of contamination of samples, minimize biohazard exposure to laboratory technicians, decrease turn-around time for aliquoting and running the assay, and eliminate some or all human error inherent with manual sample transfer procedures.

As used herein, “fluid” may refer to liquids, homogenous or heterogeneous solutions, colloids, suspensions, gases, gas-infused liquids, or other applicable species as may be determined by one of skill in the art after review of this disclosure. Particularly, “fluid” may refer to medical fluids, such as urine, amniotic fluid, CSF, serums, pericardial fluid, abscess aspirate, whole blood, serum, plasma or other blood products or other bodily fluids.

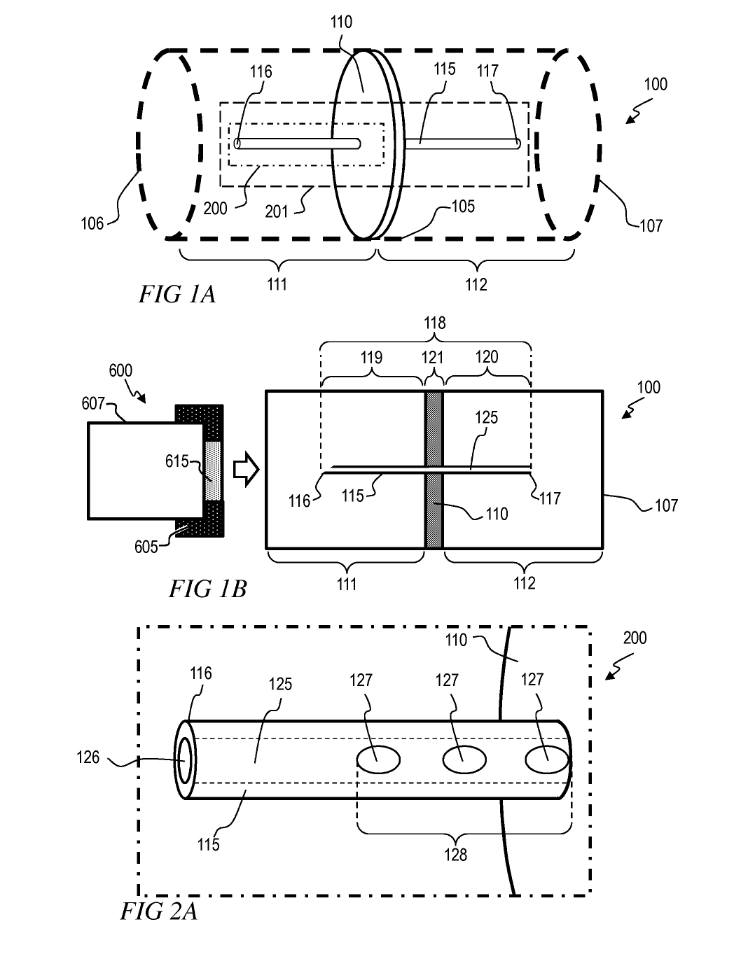

FIG. 1A illustrates a perspective view of an aliquot transfer sample tube adaptor 100 comprising a body 105, a first end 106, a second end 107, a support means 110, a first receiving cavity 111, a second receiving cavity 112, a needle 115, a first needle tip 116, a second needle tip 117, and a lumen 125. FIG. 1B further illustrates a cross-sectional view of an aliquot transfer sample tube adaptor 100 comprising a body 107, a support means 110, a needle 115, a first needle tip 116, a second needle tip 117, a tip-to-tip needle length 118, a needle first length 119, a needle second length 120, and a middle needle length 121. Fluid vessel 600 is positioned to mate with tube adaptor 100 and comprises a body 607, a cap 605, and a pierceable membrane 615. Tube adaptor 100 optionally comprises an exterior or interior edge or lip (not shown), or other means, which secures the adaptor to the tube or tubes.

Tube adaptor 100 is capable of receiving fluid vessel 600 in first receiving cavity 111, wherein needle tip 116 can pierce membrane 615 and establish fluid communication between body 607 and needle lumen 125. The membrane creates a fluid-tight or substantially fluid-tight seal around the needle. Membranes are fashioned from any suitable material, such as elastomeric or polymeric materials, such that a liquid-tight seal is created upon removal of a needle. Needle tips 116 and 117 can be diagonal or flat, as respectively shown, or shaped in other various manners. Factors for needle tip shape can depend on needle diameter, needle wall thickness, needle material, membrane material to be pierced, or other factors as can be determined by one of skill in the art after careful review of this disclosure. Body 105 can be constructed of rigid, semi-rigid, or flexible materials, depending on the desired use. For example, a rigid or semi-rigid body can be used to hold a mated fluid vessel in place. In other examples, a lip or an edge would be located on the interior of body 105, for the purpose of securing the adaptor to the tube or tubes. In other examples, a more flexible body may be used as a safety precaution against fluid spray during mating or un-mating of a tube adaptor with one or more fluid vessels.

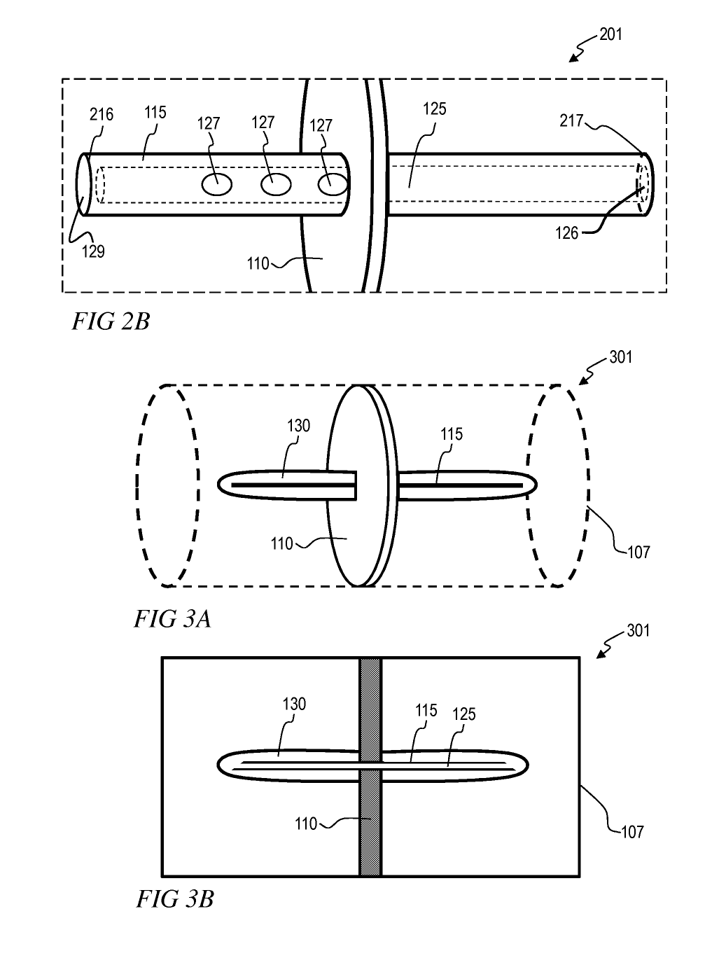

FIG. 2A illustrates a perspective view of an aliquot transfer sample tube adaptor 200 needle 115 having multiple apertures shown in relation to a support means 110 and comprising a first tip 116, a lumen 125, a needle tip aperture 126, a plurality of radial apertures 127, and a radial aperture cluster region 128. FIG. 2B illustrates a perspective view of an aliquot transfer sample tube adaptor 201 having a plurality of various needle apertures, comprising a support means 110, a needle 115, a first needle end 216, a second needle end 217, a lumen 125, a needle tip aperture 126, a plurality of radial apertures 127, and a capped needle end 129. Some advantages of various numbers and positions of needle apertures will be discussed below.

FIG. 3A illustrates a perspective view of an aliquot transfer sample tube adaptor 301, comprising a body 107, a support means 110, a needle 115, and a needle sheath 130, according to one or more techniques of this disclosure. FIG. 3B also illustrates a cross-sectional view of the aliquot transfer sample tube adaptor 301, additionally showing a lumen 125. A needle sheath 130 can aid in keeping a needle sterile before use, and provide a degree of protection by isolating the needle tip.

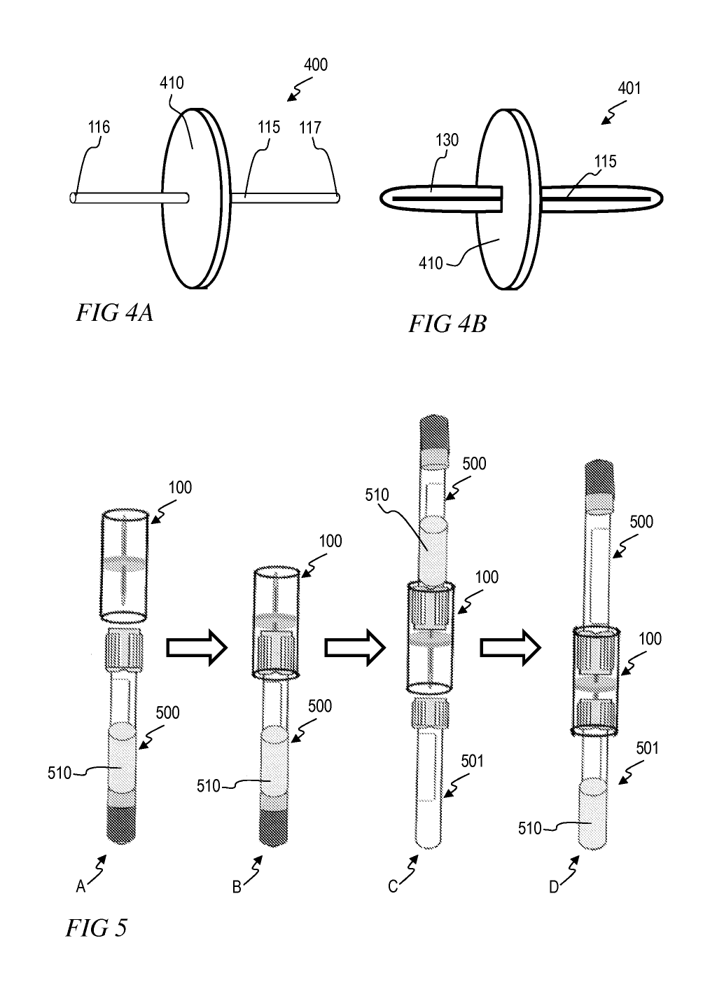

FIG. 4A illustrates a perspective view of a bodiless aliquot transfer sample tube adaptor 400 comprising a support means 410, a needle 115, a first needle tip 116, and a second needle tip 117. FIG. 4B illustrates a perspective view of a bodiless aliquot transfer sample tube adaptor 401, comprising a needle 115, a support means 410, and a needle sheath 130. These embodiments can be practiced with any other variations as described herein. For example, the bodiless aliquot transfer sample tube adaptors 400 and 401 may have a plurality of tip and/or radial apertures. The bodiless construction can increase versatility of use with variously sized fluid vessels and additionally save on material cost and cost of manufacture. In some embodiments, the bodiless aliquot transfer sample tube adaptor can be coupleable to and/or uncoupleable from a separate body piece.

FIG. 5A illustrates a flow diagram of using an aliquot transfer sample tube adaptor to transfer a sample between a plurality of sample vessels, which can describe a partial or complete fluid transfer method 530. Step A depicts a tube adaptor 100 being positioned to mate with a sample tube 500 containing a liquid sample 510. Step B depicts the tube adaptor 100 mated to the sample tube 500. Step C depicts the tube adaptor 100 positioned to mate with an aliquot tube 501. Step D depicts the tube adaptor 100 mated with the sample tube 500 and an aliquot 501, wherein fluid communication is established therebetween and the fluid sample 510 is transferred to aliquot tube 501. Transfer may occur as a result of gravity, pressure differences between sample tube 500 and aliquot tube 501, or other factors. In some embodiments, sample tubes and/or aliquot tubes can each comprise a plunger-type element at the base to provide positive pressure and/or suction to facilitate fluid transfer. Similarly, vent ports may be used to maintain ambient pressure within the tubes, or manipulate pressure via an external pump or compressor.

In some embodiments, all fluid is transferred to an aliquot tube. In other embodiments, a portion of the fluid is transferred to an aliquot tube. In some other embodiments, a portion of the fluid is transferred to each of a plurality of aliquot tubes, which can be arranged in a queue. Tube adaptor 100 may be utilized to transfer fluid to, from, and/or between fluid vessels in a queue as described in method 530 of FIG. 5A, or any other applicable transfer methods described herein or those which one of skill in the art would recognize as applicable after review of this disclosure.

Transfers can be executed manually by laboratory personnel or by an automated process or machine, including, but not limited to, a Secure Aliquoting Machine (SAM). A SAM may comprise a robotic arm attached to a sensored tip. In some embodiments, sensored tips may be metal or plastic, or a combination thereof. A metal tip can use a probe which is sensitive to electrical resistance, while a plastic tip uses a change in pressure to sense a liquid. Use of an aliquot transfer sample tube adaptor as described herein in addition to or as an alternative to sensored tips can provide increased device efficiency and performance, as significantly reduce device costs.

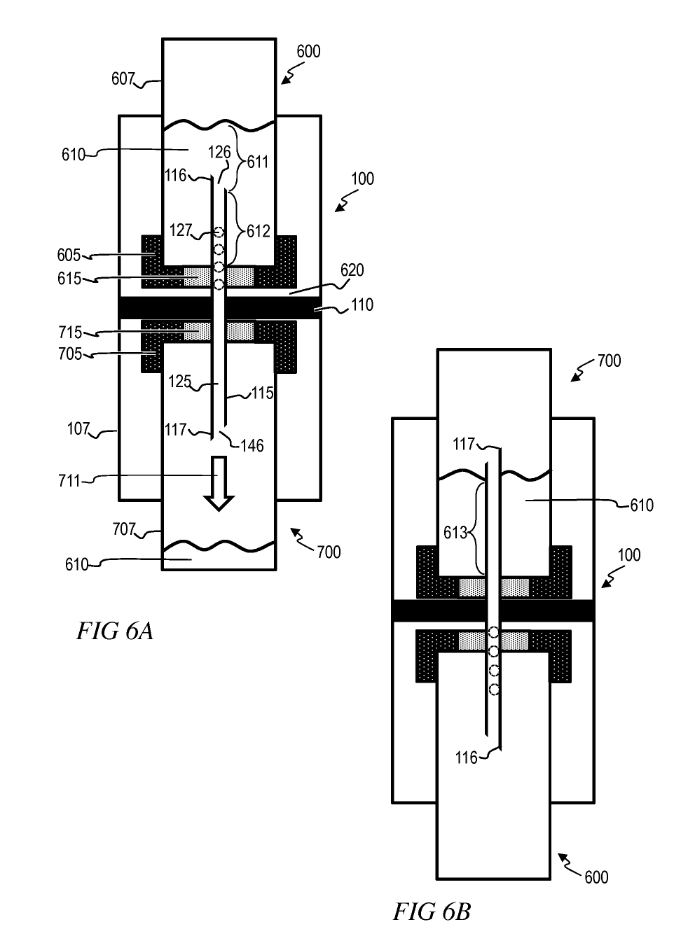

For further demonstration of fluid transfer techniques, and others, FIG. 6A and FIG. 6B illustrate a cross-sectional view of an aliquot transfer sample tube adaptor 100 mated with two fluid vessels 600 and 700, each having bodies 607 and 707, respectively, caps 605 and 705, respectively, with each cap having a pierceable membrane 615 and 715, respectively. The tube adaptor 100 comprises a body 107, a support means 110, and a needle 115 having a first end 116 and a second end 117. The needle comprises a needle tip aperture 126 and 146 at each of the first end 116 and the second end 117, respectively, and a cluster of radial apertures 127 located intermediate the support means 110 and the first tip 116. In addition, one or more, or a cluster of radial apertures 127 can be located intermediate the support means 110 and the second tip 117 (not shown). A tube adaptor 100 is considered to be mated when a needle tip, such as 116 or 117, pierces the pierceable membrane, such as 615 or 715, and enters the body of a sample tube, such as 607 or 707, respectively, thereby creating fluid communication between the body 607 or 707 and the needle lumen 125. A gap 620 may exist between a tube adaptor 110 support means 110 and a fluid vessel 600 cap 605 or pierceable membrane 615 during mating.

FIG. 6A indicates the direction of fluid flow 711 a fluid sample 610 transfers from fluid vessel 600 to fluid vessel 700 via the needle lumen 125. The number and placement of needle apertures can enhance the rate of fluid flow between fluid vessels and/or through a needle lumen, and also allow for more complete transfer of fluid. A needle having only one needle tip aperture, such as 126, can only transfer an amount of fluid 611 from fluid vessel 600 to fluid vessel 700 without rotating or manipulating the position of the mated elements 100, 600, and 700. Radial apertures 127 allow for all or substantially all of fluid sample 610 of fluid vessel 600, e.g., fluid portion 611 and fluid portion 612, to transfer to fluid vessel 700. In some embodiments a plurality of radial apertures 127 enhance the speed of fluid transfer and allow for versatility of use with fluid vessels having pierceable membranes of varying thicknesses.

In some embodiments it may be advantageous to exclude radial apertures, or include radial apertures only on certain portions of a tube adaptor needle. FIG. 6B shows an inverted orientation of elements 100, 600, and 700 from that of 6A after complete transfer of fluid sample 610 between fluid vessel 600 and fluid vessel 700 has been effected. As shown, fluid level 613 is below needle tip 117 and backflow of fluid sample 610 into fluid vessel 600 is not possible in the current orientation.

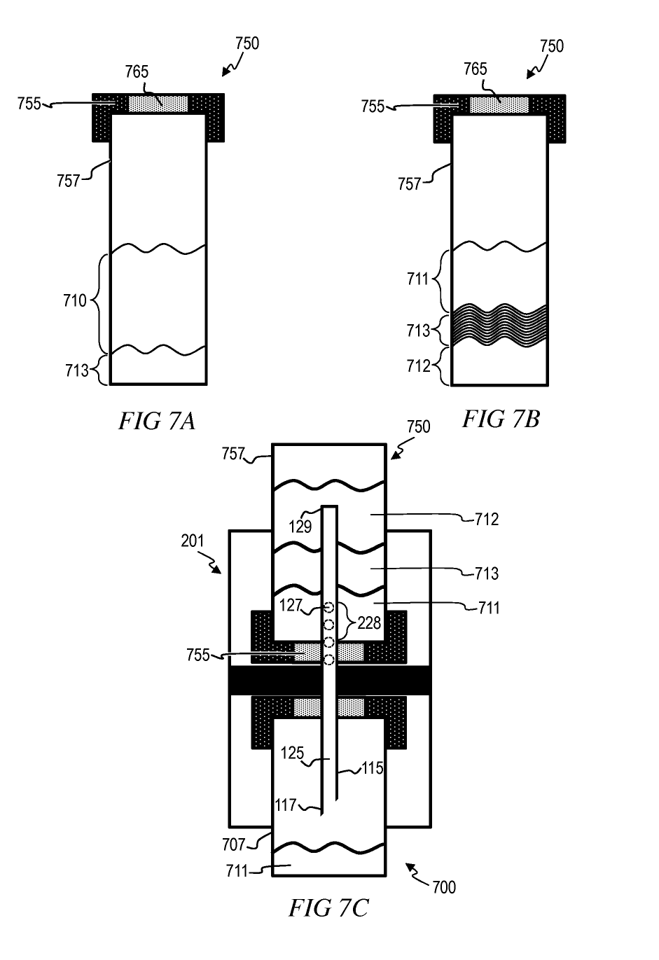

FIG. 7A illustrates a cross-sectional view of a sample vessel 750 containing a fluid sample 710 and a separating gel 713, wherein sample vessel 750 comprises a cap 755 having an integrated pierceable membrane 765. FIG. 7B illustrates a cross-sectional view of a sample vessel 750 containing a fluid sample 710 separated into its components 711 and 712 by a separating gel 713. In some embodiments, a separating gel 713 is introduced into the sample tube 750 to separate fluid components before or during fluid transfer. For example, a separating gel may be denser or heavier than blood plasma and lighter or less dense than other cellular components or cellular debris. In some examples the gel 713 may be combined in a sample tube 750, such as a typical blood collection BD Vacutainer or similar container, with a blood sample 710 and centrifuged to produce a multi-layered fluid arrangement within the tube wherein the blood cellular components 712 are positioned at the bottom of the tube and the gel 713 is positioned above, separating the cellular components 712 from the blood plasma 711 at the top of the arrangement. In other examples, component separation may occur by natural settling or other methods.

In some embodiments the sample tube 750 position may be manipulated, such as wholly inverted, and the gel will hold a constant position and prevent movement of the blood cellular components. In some embodiments the gel position may change, but a complete or substantially complete isolation of the blood cellular components and blood plasma will be maintained. During a partial or complete inversion of the sample tube, the blood plasma can freely flow to the top or capped end of the tube where it may be extracted using any of the techniques described herein.

FIG. 7C illustrates a cross-sectional view of a sample vessel 750 containing a fluid sample separated into components 711 and 712 by a separating gel 713, the sample vessel 750 being mated with an aliquot transfer sample tube adaptor 201 and a fluid vessel 700. FIG. 7C demonstrates the advantages of the needle 115 aperture configuration of tube adaptor 201 when transfer of fluid portion 711 is desired. Radial apertures 127 create fluid communication with fluid sample 711 and the needle 115 lumen 125 allowing fluid sample portion 711 to transfer into fluid vessel 700. Separating gel 713 and needle capped end 129 prevent fluid communication between needle lumen 125 and fluid portion 712. In some embodiments, separating gels comprise a viscosity sufficient to prevent gel flow through needle apertures. Radial aperture cluster region 228 can be designed based on factors such as pierceable membrane 755 thickness, amount of fluid sample, separating gel types, and number and thicknesses of various fluid layers.

In all embodiments herein, the length of one or both aliquot transfer sample tube adaptor needles can depend on one or more of a variety of factors such as the height of a sample tube, the thickness of a pierceable sample tube cap, the amount of fluid being transferred between one or more tubes or sample vessels, the number and the location of radial apertures desired, or a particular layered fluid arrangement within the sample tube. In certain embodiments, having a plurality of radial apertures on the aliquot transfer sample tube adaptor needle ensures that the maximum amount of serum or plasma or other fluid will be transferred from the tube containing the sample to the aliquot tube, independent of the thickness of the pierceable membrane or tube cap. In some embodiments, needle length is determined independently from or in cooperation with the number and/or position of needle.

Throughout this disclosure embodiments of aliquot sample transfer tube adaptors may be described as having one or two needles, although the functional difference between either construction should be construed as minimal, as a two needle configuration will comprise two needles in fluid communication unless otherwise indicated. One of skill in the art after review of this disclosure will appreciate the benefits of a one or two needle construction, such as in ease or cost of manufacture, yet will readily appreciate the applicability of either construction for the techniques described herein.

Further, “needle” as used herein can describe lumenous shafts, or other blunt, sharp, or semi-sharp shafts which can be used to puncture, pierce, penetrate, or otherwise disrupt a seal or enclosure, such as a pierceable membrane.

“Pierceable membrane” as used herein, should be construed to refer to any element which closes, seals, shuts, or otherwise preserves an opening. Pierceable membranes are able to be pierced by sharp objects, such as needles, without leaking fluid, air, or other material around the pierced area. As provided herein, the pierceable membranes of the techniques described herein are capable of reclosing, resealing, self-healing, rehealing, or reshooting once the sharp object is removed from the pierceable membrane. The pierceable membrane described herein is able to recover the ability to be fully sealed or closed. Further, as provided herein, pierceable membranes are capable of retaining a needle or other object used to puncture the stopper without allowing fluids or materials to leak, seep, pass or flow around the area of the stopper that is retaining the needle or object.

The pierceable membrane can be made of rubber, latex, polymeric materials, or any suitable bio-compatible material, or a combination thereof. The pierceable stopper is made of one or more materials that are able to be sterilized via medically approved and acceptable means, and able to be pierced or punctured by an object, including but not limited to a sharp object, such as a needle, without leaking, seeping, passing or flowing around the area of the stopper that is retaining the needle or object. The pierceable stopper is self-healing, gas proof, solvent proof, and liquid proof.

In some embodiments, pierceable membranes can be replaced by, or used in conjunction with, other sealing elements such as check valves, luer locks, or other self-sealing element, or edges, lips or ridges which one of skill in the art would identify as applicable to the techniques described herein after review of this disclosure. These alternative or additional sealing elements can be actuated, unseated, or otherwise removed from a sealing position or condition by a needle, a shaft, or other suitable means. For example, one or more needle tips of an aliquot transfer sample tube adaptor may be used to unseat a check valve from a sealing position. Examples of luer locks or check valves suitable for use with aliquot sample tube adaptors, sample transfer systems and transfer methods provided herein are found in the art, including but not limited to U.S. Pat. No. 5,984,373.

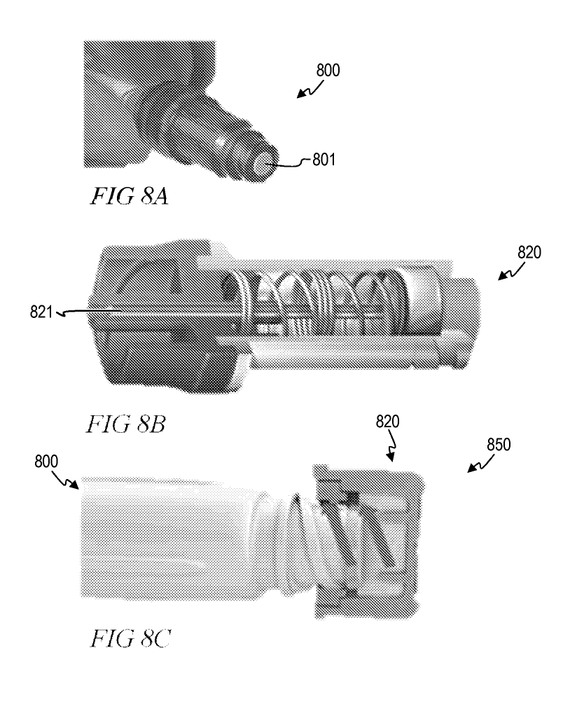

FIG. 8A illustrates a device 800 comprising needleless access port 801, which may be incorporated with one or more techniques of this disclosure. For example, a needle tip of an aliquot transfer sample tube adaptor may be used to unseat or disrupt a sealing position or condition of the needless access port 801 to create fluid communication between the device 800 and the adaptor.

FIG. 8B illustrates a luer-locking adaptor with a springed actuator 821, which may be incorporated with one or more techniques of this disclosure. For example, an aliquot transfer sample tube adaptor may comprise one or a plurality of springed actuators. Actuator 821 can comprise a lumen. Actuator 821 can comprise a one or a plurality of apertures. FIG. 8C illustrates device 800 mated with a luer-locking adaptor 820, which may be incorporated with one or more techniques of this disclosure.

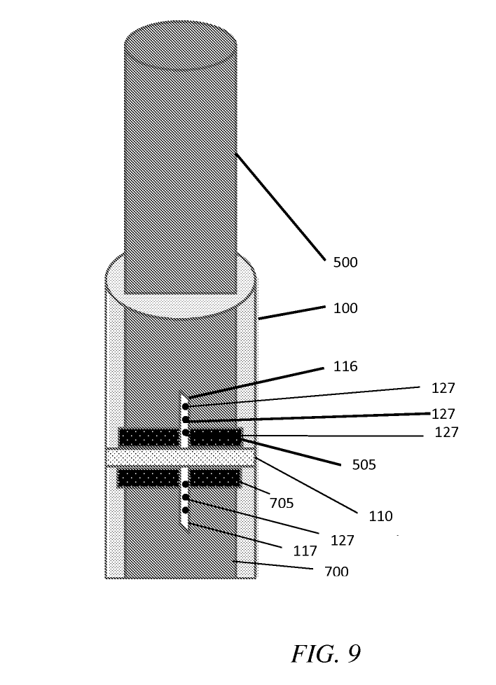

FIG. 9 illustrates a cross-sectional view of an aliquot transfer sample tube adaptor 100 mated with two fluid vessels 500 and 700, each having bodies (not enumerated), caps 505 and 705, respectively, with each cap having a pierceable membrane (not shown). The tube adaptor 100 comprises a body, a support means 110, and a needle having a first end 116 and a second end 117. The needle comprises a needle tip aperture at each of the first end 116 and the second end 117, respectively, and a cluster of radial apertures 127 located intermediate the support means 110 and the first tip 116 and another cluster of radial apertures 127 located intermediate the support means 110 and the second tip 117.

All publications, patents, and patent documents are incorporated by reference herein, as though individually incorporated by reference.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. An aliquot transfer sample tube adaptor, the adaptor comprising:
a body having a first end and a second end with an axial internal bore running therebetween;
a support means intermediate the first end and the second end defining a first receiving cavity and a second receiving cavity; and
a needle substantially axially oriented within the internal bore and maintained in position by the support means, having a first tip intermediate the body first end and the support means, and a second tip intermediate the body second end and the support means.

2. The adaptor of claim 1, further comprising a needle sheath.

3. The adaptor of claim 1, wherein the needle further comprises at least one aperture on each opposing needle side of the support means, the at least two apertures exposing a lumen internally disposed along a length of the needle.

4. The adaptor of claim 3, wherein one of the plurality of apertures is located proximate the first needle tip and the remaining plurality of apertures are located on the opposing needle side and proximate the support means.

5. The adaptor of claim 3, wherein one aperture is located proximate to each needle tip, and a radial aperture cluster is located proximate the support means on one needle side.

6. The adaptor of claim 3 wherein one or more needle apertures are sized to prevent particulate from passing therethrough.

7. The adaptor of claim 1, wherein at least one of the needle first tip and needle second tip extend beyond the body first end and body second end, respectively.

8. A sample transfer system comprising:
a sample vessel adaptor comprising:
a body having a first end and a second end with an axial internal bore running therebetween;
a support means intermediate the first end and the second end defining a first receiving cavity and a second receiving cavity; and
a needle substantially axially oriented within the internal bore and maintained in position by the support means, having a first tip intermediate the body first end and the support means, and a second tip intermediate the body second end and the support means; and
a plurality of vessels each having a sealing means actuable between a sealed position and an unsealed position by a tip of the adaptor needle when positioned within a receiving cavity of the adaptor,
wherein one or more of a plurality of vessels may be sequentially coupled via the sample vessel adaptor creating fluid communication therebetween.

9. The system of claim 8, wherein the needle further comprises at least one aperture on each opposing needle side of the support means, the at least one aperture on each opposing needle side of the support means expose a lumen internally disposed along a length of the needle.

10. The system of claim 8 wherein the sealing means of one or more of a plurality of vessels comprises a pierceable membrane.

11. The system of claim 8 wherein the plurality of vessels are positioned in a queue structure.

12. A method for transferring fluid between vessels each having a sealing means, the method comprising:
providing a sample vessel adaptor comprising:
a body having a first end and a second end with an axial internal bore running therebetween;
a support means intermediate the first end and the second end defining a first receiving cavity and a second receiving cavity; and
a needle substantially axially oriented within the internal bore and maintained in position by the support means, having a first tip intermediate the body first end and the support means, and a second tip intermediate the body second end and the support means;
positioning a sample vessel within the first receiving cavity of the adaptor thereby causing the first needle tip to actuate a sealing means of the sample vessel from a sealed position to an unsealed position; and
positioning an aliquot vessel within the second receiving cavity of the adaptor thereby causing the second needle tip to actuate a sealing means of the aliquot vessel from a sealed position to an unsealed position;
wherein fluid communication is established between the sample vessel and the aliquot vessel and fluid is transferred therebetween.

13. The method of claim 12, wherein the needle further comprises at least one aperture on each opposing needle side of the support means, the at least two apertures exposing a lumen internally disposed along a length of the needle.

14. The method of claim 12, wherein fluid communication is established between the sample vessel and the aliquot vessel via the needle lumen.

15. The method of claim 12, wherein the sealing means of one or more of the aliquot vessel or the sample vessel comprises a pierceable membrane.

16. The method of claim 12, further comprising inverting the coupled adaptor, sample vessel, and aliquot vessel to aid fluid flow into the aliquot vessel.

17. The method of claim 12, further comprising labeling an aliquot vessel only while coupled to the sample vessel via the adaptor.

18. The method of claim 12, further comprising adding a separating gel to the sample tube to separate fluid components.
